(19) United States
(12) Patent Application Publication
(10) Pub. No.: US 2004/0051325 A1
(43) Pub. Date: Mar. 18, 2004

(54) Gripping means

(76) Inventor: Gerhard Gressbach, Obernburg (DE)

Correspondence Address: CLARK & BRODY, Suite 600, 1750 K Street, NW, Washington, DC, 20006, US

(21) Appl. No.: 10/636,776

(22) Filed: Aug. 8, 2003

(30) Foreign Application Priority Data
Aug. 13, 2002 (DE) 20212400.2

(51) Int. Cl. B66C 1/28

(52) U.S. Cl. 294/82.13; 294/103.1

(57) ABSTRACT

The invention concerns locking and unlocking of gripper devices 10 raising and lowering construction components (T), large parts and the like which can be clamped between mutually displaceable gripper jaws 15, 45 of an overall ∩-shaped carrying frame 12 by means of rocker levers 20 elastically supported on said frame, said invention also comprising a latch 30, for instance a rod to selectively lock and release the rocker lever 20. The articulation 32 of the rod 30 is situated at the free end 25 of the rocker lever 20 near a reversal pin 28 for a traction element which applies clamping forces to the gripper jaws 15, 45. A grip 34 of the rod 30 may snap into a notch 40 at the periphery of the carrying frame 12 which is fitted in its upper region with a stop 38 acting as a rocker articulation when the disengaged rod 30 is pivoted upward. A mating stop 36 catches the disengaged rod 30 near a reversal pin 28 of the rope system Z. The carrying frame 12 is fitted with a limit stop 18 for the free end 25 of the rocker lever 20, said limit stop simultaneously constituting a reversal pin for the traction element Z, for instance closely below a suspension slot 14 in the upper portion of the carrying frame 12. The distances of the reversal pins 18, 28 are adjustable relative to each other and/or relative to the affixation point 16. At least one of the reversal pins 18, 28 and/or the affixation point 16 is supported in swiveling manner to compensate pivoting displacements of the construction component T or deformations of the traction element Z illustratively made of a polyester band.

### FIELD OF INVENTION

The invention relates to apparatus for locking and unlocking gripper devices lifting and lowering large parts, construction components and the like as defined in the preamble of claim 1.

### BACKGROUND OF INVENTION

Transporting loads such as slabs or panes made of steel, concrete, plastic or wood, generally speaking large parts, requires hoisting equipment such as pulleys and winches which must move vertically at least at the beginning and end of transportation. Illustratively rope or chain systems are used to seize a load around which they are placed and which they hold in place in frictional/compressive manner during the motion. When this procedure is too cumbersome or only the upper rim shall be accessible, grippers will be used. If enough space is available, wide scissors grippers may be used that shall close upon applying to them an upward traction as soon as a locking pawl allows that motion whereby the load is seized and held between clamping jaws. Thanks to a lever's mechanical advantage, the compressive force is about twice the load's weight.

Other gripper equipment such as pipe suspension gear operates by means of a rope or chain system on a generally two-arm lever configuration,spanning the load like a bail and seizing them by the bail ends when a traction, which typically may be twice or three times the weight of the load, is applied by means of appropriate reversing rollers and articulations to a pivoting lever. The British patent document 1,063,857 A describes a gripper of which the traction band or chain system is guided in S-manner over reversing rollers and engages in articulating manner a rocker lever which is prestressed by a tension spring toward a fixed jaw element and which when the load is being lifted will be pressed against this load.

The German patent document 43 39 609 C2 describes a clamping jaw device equipped with at least one safety lever to grip from below plates/slabs which must be transported, said lever automatically opening or being pivoted as soon as the load has been deposited.

Safety regulations moreover require apparatus preventing the grippers or clamps from automatically disengaging from the load when this load no longer is applied. This goal is attained in general by a spring system compressing the movable jaw, which as a rule is a compression plate, against the load. This design entails the drawback, for instance as regards suspensions of multiple rope/cable systems that the clamp or gripper first must be opened using one hand against the spring force and then must be lifted from the load with the other hand. If the loads for instance are manhole rings, then the operator is required to bend widely forward during this work and his spine shall be substantially stressed, entailing significant health risks at weights up to 20 kg (200 N).

### SUMMARY OF INVENTION

A considerable objective of the present invention is to overcome the above and other drawbacks of the state of the art by means of a simple apparatus supporting opening the clamp/gripper against the spring force and moreover keeping said device open. This apparatus moreover may be manufactured economically and is easily operated. The purpose of the invention is to absorb even large loads while itself being of low overall weight and to be always reliable even under rough conditions of construction.

The main features of the present invention are stated in claim 1. Further developments are the objects of claims 2 through 20.

Apparatus for locking and unlocking grippers raising and lowering structural members, large construction parts and the like that may be clamped by two gripper jaws moving toward each other makes use of a carrying frame in general assuming a ∩ shape and fitted with a rocker lever in such a configuration that a first gripper jaw rigidly joined to the support member is situated opposite a second gripper jaw linked to the rocker lever, a traction element guided along an S path over reversal pins or rollers engaging in particular the upper region of said support member, said traction element initiating clamping forces by the gripper jaws. In the present invention, a latch is mounted on the rocker lever and selectively locks and releases said locking lever. In this manner safety at work is considerably enhanced using simple means, namely in that—using one hand—the rocker lever may be moved out of the locked into the steady open position, and vice versa. Also the load can be clamped and released more quickly than before and substantial time savings are attained, foremost when several transporting tasks must be carried out in rapid succession with that one apparatus.

While the German utility model document 295 10 732 U1 discloses a hoist for manhole-rings which is fitted with a traction or drive rod of which the upper end may be snapped by a prestressed spring latch into one pivoting position, it does not allow freezing the gripper-jaw's open position. Moreover this design constitutes a clip of which one leg comes to rest perpendicularly against the load and away from a support arm, whereas a second leg mounted in adjustable manner on said support arm shall press by means of an elbow lever a compression element against the load as soon as traction is applied to the pivotable drive rod. This drive rod however is linked to a rigidly affixed extension arm (a compression rod) of the displaceable leg and consequently it is able at best to apply traction on the elbow lever only if the second leg is able to pivot somewhat about the support arm, that is, if it is affixed with chatter play as is the case for simple screw clamps. Another drawback of this design is that in known manhole-ring hoists of the state of the art, the jaws' gripping width is adjustable only discretely and only within a narrow range.

In one embodiment, the articulation of the latch is mounted on that end of the rocker lever of which the bearing is opposite the carrying frame. Consequently the full length of the rocker lever is made use of during locking and unlocking. If now the latch's articulation is configured near a reversal pin or roller of the rope system, then this rope system may be maximally expanded in the transverse position as regards the open position, and the aperture width or the possible open jaw size of the gripper device will be especially large.

Preferably the latch shall be a rod of which the free end can be locked into or on the carrying frame. Not only is this rod economically manufactured and assembled, but also it is easily seized and handled. To engage a grip of the latch, the carrying frame is fitted at its upper zone and preferably opposite the rocker lever's bearing with a notch, recess or the like acting as a rest for the latch when in its engaged position. For that purpose the notch, recess or the like is configured next to a suspension slot at the top of the carrying frame where a stop acts as a rocker for the unlocked latch when it is pivoted upward. This feature extraordinarily enhances easy handling.

Operation is made easier furthermore in that the latch articulation is mounted on the rocker lever next to a mating stop and/or next to a reversal pin or roller for the rope or chain system. As a result the latch at the rocker lever's outer end is configured at a site of operation which is very near the articulation and which offers high leverage for pivoting, in particular because the mating stop and/or the rope or chain system's reversal pin is situated at the rocker lever's free end that is opposite the carrying frame's coupling point. This configuration is selected in a manner that, in the rocker lever's neutral position, the mating stop, the latch's articulation and the reversal pin are configured on an approximately straight line and are approximately equidistantly apart and thereby offer especially advantageous handling.

In especially advantageous manner, the carrying frame is fitted with a limit stop for the rocker lever's free end, as a result of which said lever's closest or neutral position is very easily implemented. In a special embodiment, the limit stop simultaneously constitutes a reversal pin for the traction element, for instance closely underneath the suspension slot.

A spring may be mounted at the carrying frame in the region of the rocker lever's bearing to bias said lever toward the neutral position. This spring furthermore ensures that the latched latch is pressed into the carrying frame's notch. An appropriate spring is a torsion spring enclosing the pivot bearing and resting by its legs on one hand against the carrying frame and on the other hand against the rocker lever. Moreover a tension or compression spring may be used in other embodiment modes.

In claim 14 the invention defines apparatus to grip and also raise or lower planar or curved components, big construction parts and the like which in particular are clamped along vertical lines or surfaces between gripper jaws, said apparatus comprising a generally ∩-shaped carrying frame bearing at one lower end a rocker lever coupled in articulating manner to a gripper jaw, said lever being configured in rigid manner opposite a second gripper jaw, and also comprising a traction element which acts on upper zone fo the carrying frame and which is guided along an S path over reversal pins and which applies clamping forces on the gripper jaws when the gripper device is raised. In this respect the invention provides that a control element shall be mounted on the rocker lever to selectively lock or release said lever, whereby handling is shall be extraordinarily simplified.

In another embodiment, the traction element passing over at least one reversal pin is a belt, for instance an endless polyester belt which drives the lever while spaced away from its pivot axis. Where there are two reversal pins, their separations from each other and/or relative to a affixation point may be made adjustable. Advantageously at least one of the reversal pins and/or the affixation point are suspended in swinging manner in order to accurately guide the traction element and to preclude deformations, pivoting motions etc.

To assure safe handling, advantageously one of the reversal pins shall be configured approximately at the common center of gravity of the gripper device and the construction part. Moreover the reversal pins and the lever's pivot axis may run substantially parallel to each other. Advantageously the traction element can be suspended from a hoisting element of hoisting equipment such as a crane, excavator, forklift etc.

### BRIEF DESCRIPTION OF THE DRAWINGS

Further features, particular and advantages of the present invention are stated in the claims and in the following description of illustrative embodiments and in relation to the appended drawings.

FIG. 1 is a sideview of a gripper device in its neutral position,

FIG. 2 is a sideview of a gripper device of FIG. 1 in its open position,

FIG. 3 is a sideview of the gripper device of FIG. 1 in its clamping position, and

FIG. 4 is a sideview of pipe suspension with an axial section of a manhole ring seized by two gripper devices.

### DETAILED DESCRIPTION OF THE PREFERRED EMBODIMENTS

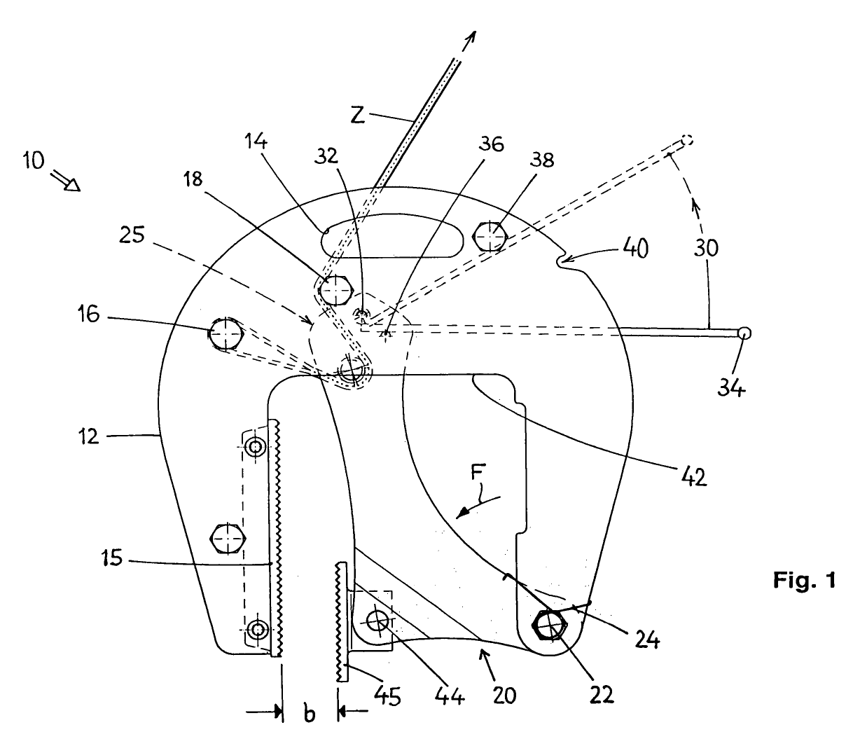

The partly schematic sideview of FIG. 1 shows a gripper device 10 in its neutral position. A ∩-shaped carrying frame 12 may be fitted in its upper region with a suspension slot 14. Said frame is fitted at one of its down-facing legs with a stationary gripper jaw 15 and above latter, yet preferably below the suspension slot 14, with an affixation element in the form of an engagement bolt 16 for a traction part, for instance a rope or chain system Z running upward around a deflection pin or roller 18. Another leg of the carrying frame 12 is fitted at its lower end with an articulation or bearing 22 for an L-shaped rocker lever 20 supporting at its end a displaceable gripper jaw 45 situated opposite the stationary gripper jaw 15. At its upper, i.e. outer free end 25, the rocker lever 20 is fitted with a reversing pin or roller 28 for the traction part Z which runs around it in an S pattern. A torsion spring 24 is used at the articulation or bearing 22 of the carrying frame 12 to bias the rocker lever 20 toward the narrowest, i.e. neutral position.

The gripper device 10 is fitted with an operational system keeping it open and comprising a latch 30 acting as the operational rod. By means of an articulation or tubular bearing 32, said rod 30 rests on the free end 25 of the rocker lever 20; the rod 30 also comprises a grip 34 at its other end. The rocker lever is wholly pivoted backward in FIG. 1 and as a result the displaceable gripper jaw 45 is situated its least distance b from the stationary gripper jaw 15. The free end 25 of the rocker lever 20 reaches the reversal pin 18 forming a limit stop. In this position the articulation 32 of the latch 30 is near the reversal pin 18. A mating stop 36 which is mounted at the free end 25 of the rocker lever 20 and also near the articulation 32 limits the downward excursion of the latch 30 to the horizontal end position shown in FIG. 1.

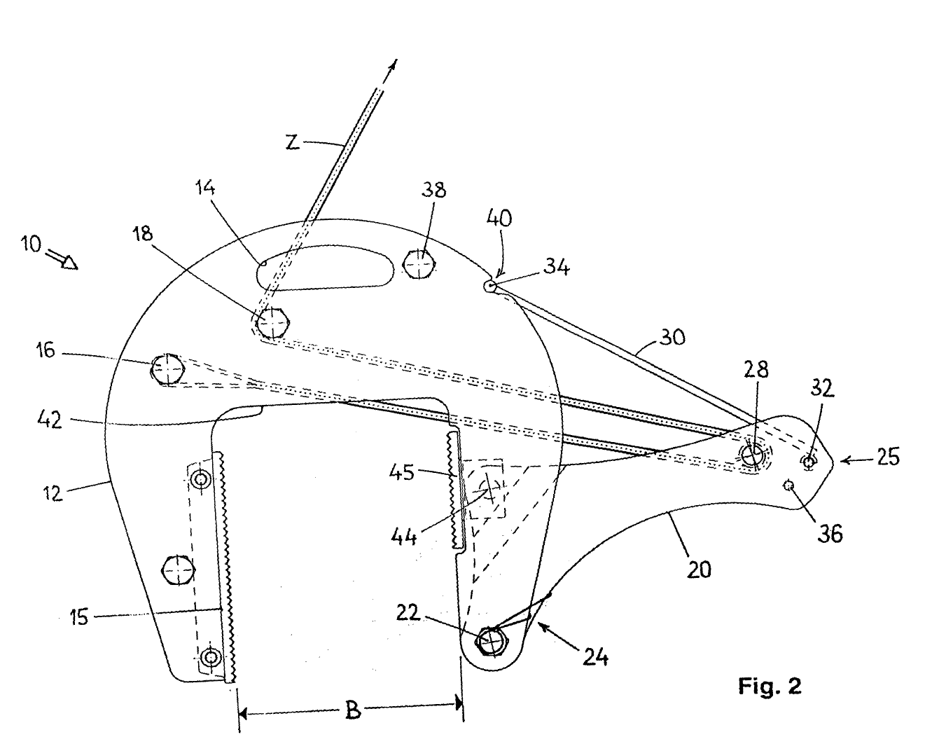

To open the gripper device, ie the clamp 10, the latch, i.e. the latch 20, is pivoted upward as indicated by an arrow. Thereupon the limit stop 38 of the carrying frame 12 stops and provides a rest for the rod 30 and consequently a rocker articulation has been created which upon further upward motion of the latch 30 supports the sideways pivoting motion of the rocker lever 20. In the process the traction element Z guided around the reversal pin 28 is stretched until the end position shown in FIG. 2 is reached wherein the grip 34 snaps into a notch 40 at the periphery of the carrying frame 12. In this position the gripper jaws 15,45 are separated by the maximum distance B, that is the maximal jaw aperture. Actuating the rope system Z, the now locked apparatus may be moved freely without requiring further procedures such as having to manually remove the clamps from the load (T) omitted from FIG. 2. The drawing furthermore shows that the spring 24 is maximally stressed in the direction opposite the force F (FIG. 1). As a result, the clearance 42 of the carrying frame 12 is entirely freely accessible.

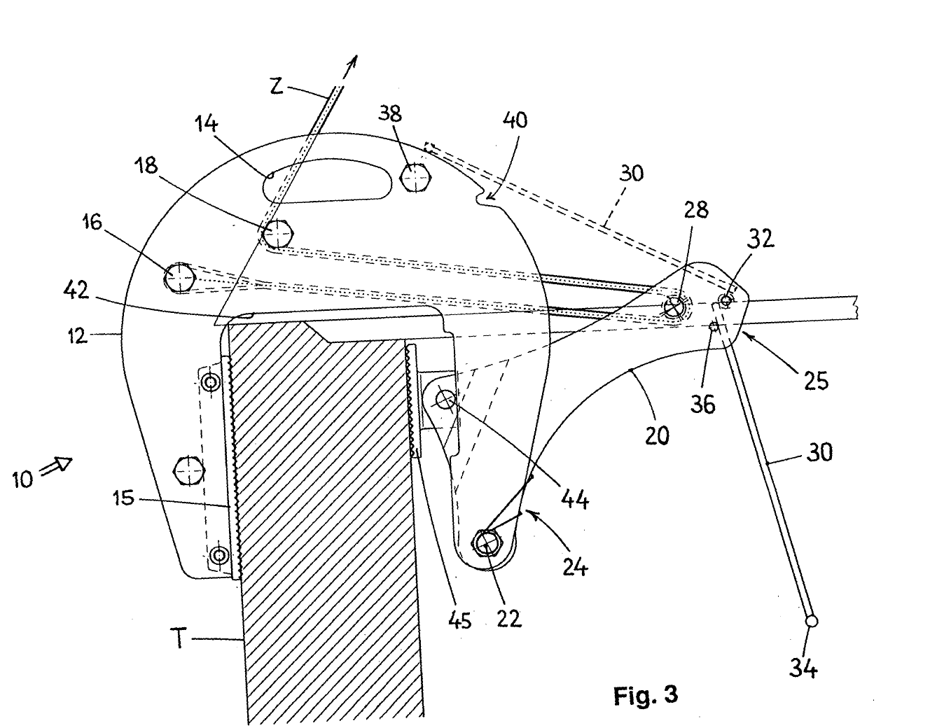

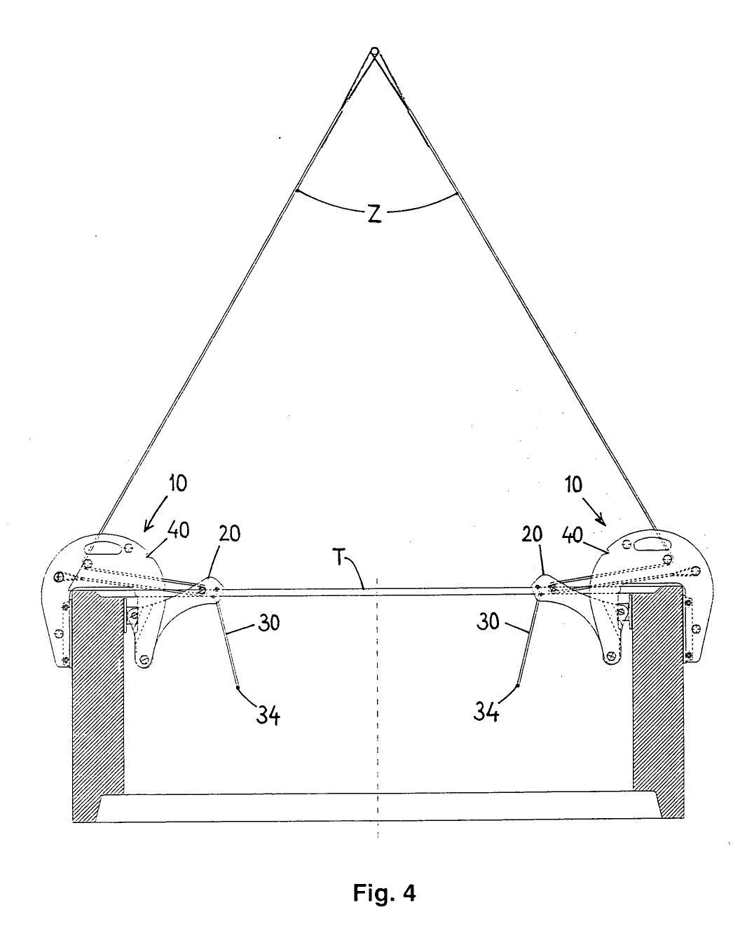

Next a load may be inserted, for instance a peripheral part of manhole ring T as shown in FIG. 3. The gripper device is closed by moving the grip 34 against the biasing force F out of the notch 40 and by pivoting the latch 30 rearward, ie outward (FIG. 3), the spring force F compressing the gripper jaw 45, which is coupled to a tipping bearing 44 of the rocker lever 20 against the load T. Thereupon the latch 30 is able to pivot downward as far as the mating stop 36 (FIG. 4), though it may also continue resting against the carrying frame 12 of the gripper device 10 as indicated by dashed lines in FIG. 3.

FIG. 4 shows how a manhole ring T is seized by two gripper devices 10 as soon as a traction is applied to the rope system Z. The rods 34 being unlocked, the rocker levers 20 have carried out a full pivoting and consequently the springs 24—which are omitted form FIG. 4—compress the movable gripper jaws 45 against the load T. The traction exerted by the rope system Z additionally compresses the rocker levers 20 and hence the displaceable gripper jaws 45 against the inside wall of the manhole ring T.

The present invention is not restricted to one of the above illustrated embodiment modes, rather it may be modified in versatile manner. For instance the operational surfaces of the gripper jaws 15, 45 may be fitted with smooth or fluted rubber coatings, and furthermore buffers made of rubber or other soft materials may be present in the hollow, ie the clearance 42 of the carrying frame 12 in order to protect the surfaces of construction parts T, other big components and the like. Nor is it foremost critical that the spreading device be fitted with a spring or springs because the important point is the ability to raise (and lower) the gripper devices 10 into a stopped position without the need for applying manual force. Again, the rope system Z may be a flat band, for instance an endless polyester belt.

It will be noted that in a preferred embodiment of the present invention regarding locking and unlocking gripper devices 10 used to raise and lower construction parts T, big components and the like which, by gripper jaws 15, 45 moving toward each other, can be clamped by means of a rocker lever 20 elastically resting on a frame 12 and mounted on said carrying frame 12 that assumes an overall ∩ shape, a latch 30 is coupled to the carrying frame 20 and allows selectively locking or releasing the rocker lever 20. The articulation 32 of the latch 30 is situated at the free end 25 of the illustratively L-shaped rocker lever 20 near a reversal pin 28 for a rope or chain system Z by means of which clamping forces can be applied to the gripper jaws 15, 45. Preferably the latch shall be a rod/bar 30 which by means of its free end or grip 34 may snap into a notch 40 configured at the periphery of the carrying frame 12. Said frame comprises at its top a stop 38 acting as a rocker for an unlocked latch 38 when being pivoted upward. A mating stop 36 captures the unstressed locking bar 30 near a reversal pin 28 of the rope Z. The carrying frame 12 is fitted with a limit stop 38 for the free end 25 of the rocker lever 20 and this stop 38 simultaneously acts as a reversal pin for the rope or chain system Z and is situated tightly below a suspension slot 14 in the upper part of the carrying frame 12. The distances of the reversal pins 18, 28 between each other and/or relative to the affixation point 16 are adjustable in order to match the point of suspension to different centers of gravity or to vary the height of the clamping force. At least one of the reversal pins 18, 28 and/or the affixation point 16 may be supported in rocking manner. Pivoting motions of the construction part T or deformations of the traction element Z outside the gripper device 10 can therefore be compensated in problem-free manner. Also the traction element Z may be made of another plastic or textile. Said traction element however must exhibit high resistance to tear and low weight.

All features and advantages, inclusive design details, spatial configurations and method steps based on the claims, the specification and the drawings may be significant for the invention both per se as in the most diverse combinations.

1. Apparatus for locking and unlocking gripper devices (10) raising and lowering construction components, large parts and the like that may be clamped between mutually displaceable gripper jaws (15, 45) which are configured in such manner in an overall ∩-shaped carrying frame (12) and on a rocker lever (20) supported by said frame that a first gripper jaw (15) rigidly joined to the carrying frame (12) is situated opposite a second gripper jaw (45) coupled to the rocker lever (20), a traction element (Z) being guided in an S path in particular in the upper region of the carrying frame (12) over reversal pins (18, 28), said traction element allowing applying clamping forces to the gripper jaws (15, 45), characterized in that a latch (30) is coupled to the rocker lever (20) and allows selectively locking or releasing said lever (20).

2. Apparatus as claimed in claim 1, characterized in that the articulation (32) of the latch (22) is mounted on said rocker lever's (20) free end (25) which is situated opposite the articulation (22) of the carrying frame (12).

3. Apparatus as claimed in claim 1, characterized in that the articulation (32) of the latch (30) is situated near a reversal pin or roller (28) of the rope or chain system (Z).

4. Apparatus as claimed in claim 1, characterized in that the latch is a rod (30) which can snap into position at its free end into or onto the carrying frame (12).

5. Apparatus per claim 4, characterized in that the carrying frame (12) is fitted with a clearance, notch (40) or the like at its upper region to engage a grip (34) of the latch (30).

6. Apparatus as claimed in claim 5, characterized in that the clearance, notch (40) or the like is configured opposite the bearing (22) of the rocker lever (20), namely next to a suspension slot (14).

7. Apparatus as claimed in claim 5, characterized by a stop (38) in the upper region of the carrying frame (12) and acting as a rocker articulation for the unlocked latch (30) when it is pivoted upward.

8. Apparatus as claimed in claim 1, characterized in that the articulation (32) of the latch (30) is mounted on the rocker lever (20) near a mating stop (36) and/or near a reversal pin (28) for the rope or chain system (Z).

9. Apparatus as claimed in claim 8, characterized in that the mating stop (36) and/or the reversal pin(28) of the rope or chain system (Z) is mounted at the free end (25) of the rocker lever (20) opposite the bearing (22) at the carrying frame (12).

10. Apparatus as claimed in claim 9, characterized in that, in the neutral position of the rocker lever (20), the mating stop (36) the articulation (32) of the latch (30) and the reversing pin (28) are approximately equidistantly juxtaposed along an approximately straight line.

11. Apparatus as claimed in claim 8, characterized in that a limit stop (18) for the free end (25) of the rocker lever (20) is present at the carrying frame (12).

12. Apparatus as claimed in claim 11, characterized in that the limit stop (18) simultaneously acts as a reversal pin for the rope or chain system (Z), and preferably is situated tightly below a suspension slot (14) of the carrying frame (12).

13. Apparatus as claimed in claim 8, characterized in that a spring (24) is mounted at the carrying frame (12) in the region of the rocker lever bearing (22) and biases the rocker lever (20) towards the neutral position of the gripper devices (10).

14. Apparatus to seize and raise as well as lower planar or curved construction components (T), large parts and the like which are clamped in particular at vertical engagement lines or surfaces between the gripper jaws (15, 45), said apparatus comprising an overall ∩-shaped carrying frame (12) fitted with a first gripper jaw (15) rigidly joined to it and supporting at a lower end a rocker lever (20) coupled in articulating manner with a second gripper surface (45), further comprising a traction element (Z) guided along an S shaped path over reversal pins (18,28) and acting on the upper region of the carrying frame (12), said traction element applying clamping forces on the gripper jaws (15, 45) when the gripper device (10) is being lifted, and further comprising a latch as defined in claim 1 to selectively lock or release the rocker lever.

15. Apparatus as claimed in claim 1, characterized in that the traction element (Z) guided over at least one reversal pin (18) is a band, for instance an endless polyester belt, and engages the lever (20) at a distance (a) from said lever's axis of articulation (22).

16. Apparatus as claimed in claim 15, characterized by two reversal pins (18, 28) of which the distances to one another and/or relative to a affixation point (16) on the carrying frame (12) are adjustable.

17. Apparatus as claimed in claim 15, characterized in that at least one of the reversal pins (18, 28) and/or the affixation point (16) is supported in swiveling manner.

18. Apparatus as claimed in claim 1, characterized in that one of the reversal pins (18) is configured approximately in the common center of gravity of the gripper device (10) and the construction part (T).

19. Apparatus as claimed in claim 2, characterized in that the reversal pins (18, 28) and the swivel pin (22) of the lever (20) run substantially parallel to one another.

20. Apparatus as claimed in claim 1, characterized in that the traction element (Z) may be suspended from a hoisting element of a hoist such as a crane, excavator, fork lift etc.

21. Apparatus as claimed in claim 14, characterized in that the traction element (Z) guided over at least one reversal pin (18) is a band, for instance an endless polyester belt, and engages the lever (20) at a distance (a) from said lever's axis of articulation (22).

22. Apparatus as claimed in claim 21, characterized by two reversal pins (18, 28) of which the distances to one another and/or relative to a affixation point (16) on the carrying frame (12) are adjustable.

23. Apparatus as claimed in claim 21, characterized in that at least one of the reversal pins (18, 28) and/or the affixation point (16) is supported in swiveling manner.
